(19) United States
(12) Patent Application Publication
(10) Pub. No.: US 2026/0103326 A1
(43) Pub. Date: Apr. 16, 2026

(54) INDUCTION COOKING VESSEL MADE FROM NON-FERROMAGNETIC MATERIALS

(71) Applicant: Kenyon International, Inc., Clinton, CT (US)

(72) Inventors: Daniel Roy, Westerly, RI (US); Michael Reischmann, Eustis, FL (US); Philip Williams, Clinton, CT (US)

(21) Appl. No.: 19/356,004

(22) Filed: Oct. 10, 2025

Related U.S. Application Data
(60) Provisional application No. 63/706,120, filed on Oct. 11, 2024.

(51) Int. Cl. B65D 81/34; A47J 36/02; H05B 6/12

(52) U.S. Cl. CPC B65D 81/3476; A47J 36/022; H05B 6/1209; B65D 2581/3421

(57) ABSTRACT

A cooking cartridge including a bottom and a sidewall forming a vessel having a cavity. Food matter is contained in the cavity and a lid closes the cavity such that the food matter is retained in the cavity when the lid is closed and such that the food matter is removable from the cavity when the lid is opened. The vessel containing a non-ferrous material which is a conductive or resistive material. In some embodiments, the non-ferrous material is aluminum.

### FIELD OF THE INVENTION

The following relates to cooking vessels for use with induction-based cookers/heaters. More particularly, the following relates to single use cooking vessels pre-filled with food for cooking with induction.

### BACKGROUND OF THE INVENTION

Induction relies on a magnetic field to generate currents in materials that result in generation of heat. Thus, ferro-magnetic materials have been generally seen as optimal for use in induction cooking. For example, U.S. Pat. No. 9,848,729 provides a cartridge in which food is cooked and includes a layer of ferromagnetic material. As described in col. 5, lines 5-30 of this patent, the oscillating magnetic field interacts with the ferromagnetic material to generate heat and the cook-top is not directly heated by induction. The cooktop is made of non-ferromagnetic materials.

Thus, in the case of cartridges for cooking food, it was believed that non-ferromagnetic materials could not be heated by induction. While ferro-magnetic materials may be suitable for use with induction and work well in this scenario for generating heat, the cost of these materials makes them unsuitable for single use cooking vessels which are preferably easy to recycle.

Thus, it would be beneficial to provide a cooking vessel such as a cartridge which can be single use and which is inexpensive to manufacture and is recyclable or preferably compostable.

### SUMMARY OF THE INVENTION

It is therefore an object of the invention to provide a cartridge for cooking food which can be single use and recyclable or compostable.

It is further an object of the invention to provide a cartridge for cooking food with induction that uses non-ferromagnetic materials.

It is further desired to provide a cartridge for cooking popcorn which is economical and provides the ability to properly cook popcorn and also do so in oils/fats and seasoning.

It is further desired to provide pre-seasoned cartridges of popcorn for cooking in various flavors.

These and other objects are achieved by providing a cartridge with a cavity that is sealed with a removable lid, the lid being removable for cooking and the cavity containing food to be cooked and preferably oil/fat and seasonings/flavors. The cartridge includes a non-ferromagnetic material which is conductive or resistive and which interacts with an oscillating magnetic field of an induction apparatus to generate heat in the cartridge to cook the food.

In one aspect a cooking cartridge is provided with a bottom and a sidewall forming a vessel having a cavity. Food matter is contained in the cavity. A lid closes the cavity such that the food matter is retained in the cavity when the lid is closed and such that the food matter is removable from the cavity when the lid is opened. The vessel contains a non-ferrous, also referred to herein as a non-ferromagnetic material, which is a conductive or resistive material.

In certain aspects the non-ferrous material is configured to interact with an induction coil to heat the food matter within the cavity. In other aspects, the food matter comprises popcorn which is un-popped. In still other aspects, the food matter further comprises a fat material. In yet further aspects, the food matter further comprises a flavor or seasoning. In yet other aspects, the fat material is a plant or vegetable based oil. In other aspects, the non-ferrous material is aluminum and the bottom and sidewalls are formed of aluminum. In still other aspects, the bottom has a thickness of 12-35 gauge. In yet other aspects, the non-ferrous material is graphite. In still other aspects, the sidewall is round and the vessel has an aspect ratio of at least 2 which aspect ratio is measured by diameter/height of the cavity. In yet other aspects, the aspect ratio is at least 3. In still other aspects, the lid is adhered to a rim or edge of the vessel with a pressure sensitive adhesive. In yet other aspects, the food matter comprises unpopped popcorn and a fat with an unpopped popcorn to fat ratio of between 30:6 and 30:15 by weight. In still other aspects, the unpopped popcorn to fat ratio is between 30:8 and 30:12. In yet other aspects, the bottom and/or sidewall are formed of a different material than the non-ferrous material. In still other aspects the bottom and/or sidewall are formed of a compostable material.

In other aspects, cooking cartridge includes a bottom and a sidewall forming a vessel having a cavity, the bottom and sidewall formed of aluminum. Food matter is in the cavity, the food matter comprising unpopped popcorn and a fat.

In certain aspects, a lid closes the cavity such that the food matter is retained in the cavity when the lid is closed and such that the food matter is removable from the cavity when the lid is opened. In still other aspects the cartridge has an unpopped popcorn to fat ratio of between 30:6 and 30:15 by weight. In still other aspects, the unpopped popcorn to fat ratio is between 30:8 and 30:12. In other aspects, the bottom has a thickness of 12-35 gauge. In yet other aspects, the sidewall is round and the vessel has an aspect ratio of at least 3 which aspect ratio is measured by diameter/height of the cavity.

Other objects of the invention and its particular features and advantages will become more apparent from consideration of the following drawings and accompanying detailed description.

### BRIEF DESCRIPTION OF THE DRAWINGS

FIG. 1 is a perspective view of a sealed cartridge according to the present invention.

FIG. 2A is a perspective view of FIG. 1 with the lid partially removed.

FIG. 2B is a cross section along line 2B/C.

FIG. 2C is an alternate cross section along line 2B/C.

FIG. 3A is a side view of the cartridge of FIG. 1.

FIG. 3B is a perspective view of the cartridge of FIG. 1 shown empty.

FIG. 4 is a perspective view of an induction cooking apparatus which receives the cartridge of FIG. 1.

FIG. 5 is a detailed cross section view of FIG. 4.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

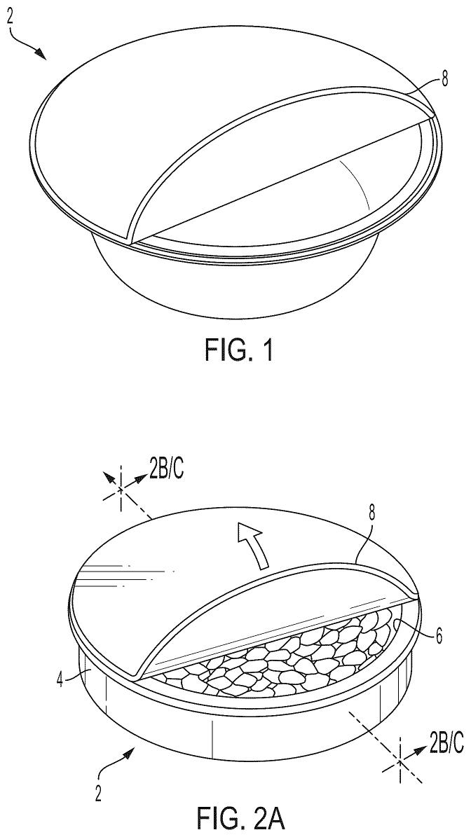

The cartridge 2 as shown in FIG. 1 has the lid in the un-removed state. In this way, food such as popcorn and the cooking oils/fats and seasoning/flavoring are retained in the cartridge. The user can then cook a single serving easily. In certain embodiments, the outer color of the wall 4 varies depending on the flavor. For example, salt flavor can have one, “movie theater” can have another color, “salt and vinegar” and “BBQ” etc can all have their own colors, allowing the user to visually identify the popcorn flavor. The lid 8 peels back easily and is removed by the user to expose the food. Preferably the lid is fully removed and the cartridge placed in the correct location/position for cooking. The cartridge as shown is round, but other shapes are contemplated. The sidewall 4 has an outer surface with the color applied to it in some cases. The inner surface 6 is preferably un-treated or covered with an appropriate temperature resistant and food safe material. In the example where the cartridge is aluminum or another conductive and non-ferromagnetic metal, the interior surface is preferably not coated/painted. In certain aspects, the non-ferrous material (e.g. aluminum) accounts for a majority of the empty cartridge/vessel by weight, for example more than 50%, more than 75%, more than 85% or even more preferably more than 90% Aluminum. This ranges can apply both including and excluding the removable lid.

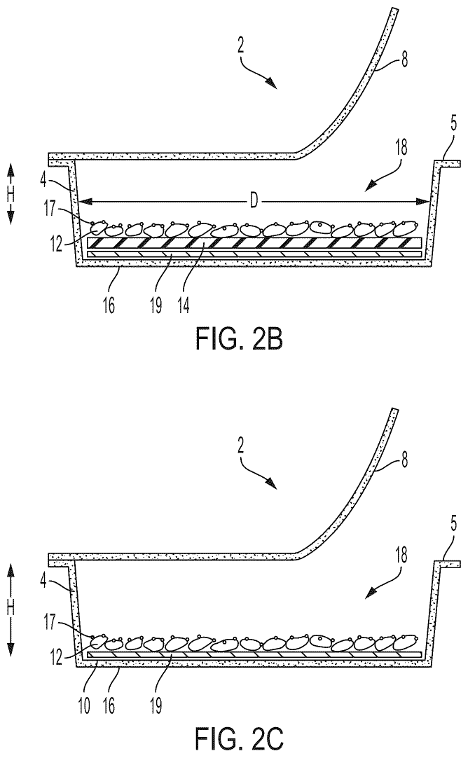

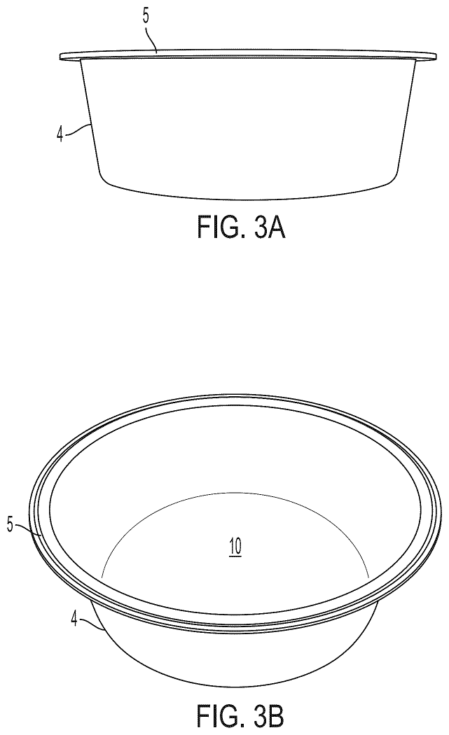

As can be seen in FIG. 2B, an example of a compostable cartridge is provided. In this case, layer 14 is provided at the bottom of the cartridge and is a non-ferromagnetic material such as a conductive material or resistive material. For example, conductive materials could include aluminum, copper, brass and other non-ferromagnetic metals. The resistor material could be e.g. graphite. In preferred embodiments, this heat plate 14 is disc shaped and has a thickness in the 12-35 gauge range. In the case of FIG. 2B, the side wall 4 and bottom 16 may be made of compostable or recyclable materials such as cardboard, paperboard, bamboo, or vegetable starch based bioplastics and combinations thereof. The inside may be coated in a high temperature wax or other compounds. As shown, the cavity 18 contains popcorn 12 along with oil 19 and seasoning 17. The seasoning 17 may be salt or other flavors alone or in combination. For example, BBQ, salt and vinegar, pepper, “movie theater” and other popcorn flavors or flavored salts are contemplated. Further, the mixture of oil to popcorn uses an appropriate amount of oil to ensure proper cooking. This ratio of unpopped popcorn to fat may be between 30:6 and 30:15 by weight, more preferably between 30:7 and 30:12 by weight. As can be seen, the lid 8 is removably secured to the edge 5 or rim/rolled edge of the cartridge, this will typically be with a pressure sensitive adhesive that preferably is better adhered to the lid such that the adhesive residue is removed from the cartridge prior to cooking once the user removes the lid, or at least such that the adhesive is substantially removed such that only trace amounts less than 20% of the original amount of adhesive remain.

The cartridge or cup is relatively wide compared to its height such that the aspect ratio D/H is relatively large. Here, the height is measured from the heating surface to the top of the rim 5 and the diameter is measured as the average diameter of the sidewall in the case that the sidewall is angled outwards as shown. In this manner, the heating surface represents a relatively large surface in comparison to the overall size/volume of the cartridge. Therefore, direct contact between the food and the heating surface is increased to encourage swift and even cooking of the popcorn/food. In preferred aspects the aspect ratio is at least 2, more preferably at least 3 or more preferably at least 3.5 or 4 or more.

In FIG. 2C the cartridge is shown without a separate heating plate 14 in that the cartridge itself provides the conductive/resistive non-ferromagnetic material. In one preferred embodiment the walls 4 and bottom 10 are made of aluminum, preferably 12-35 gauge thickness.

In both cases, the bottom surface 16 and outer surface 4 preferably rests in a cavity/receiver of the cooking device.

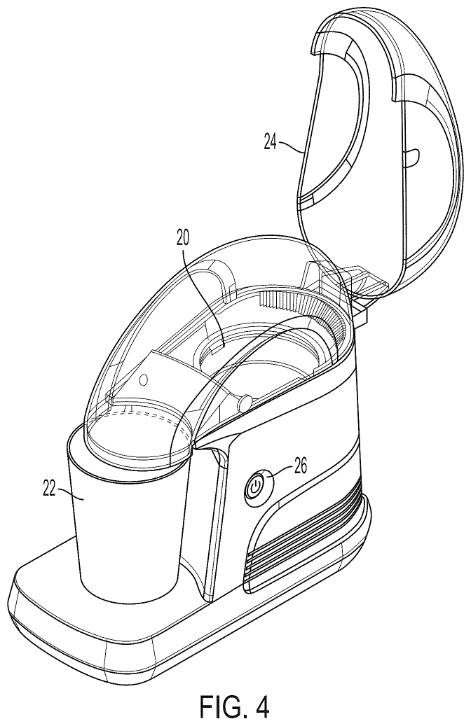

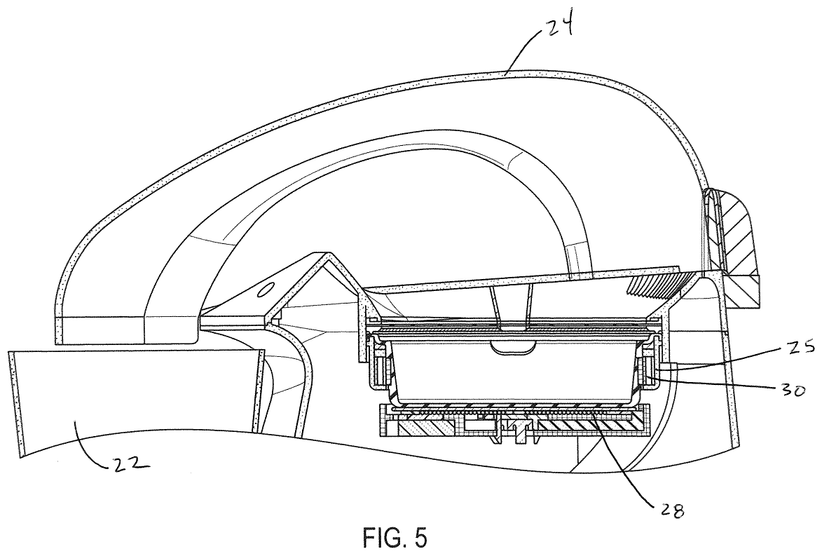

Referring to FIGS. 4-5, a cooking device is shown, in this instance an induction popcorn popper. A hinged lid 24 is provided to cover the receiver 20 that receives the cartridge 2. The lid therefore directs popped corn into the cup 22 for user enjoyment. A power switch/button 26 is activated to begin the cooking process and/or interrupt the cooking process. The induction coil 28 is provided below the receiver 25 and interacts with the conductor/resistor in the cartridge to generate heat. Preferably, the receiver 25 is a flexible/elastomeric material such as silicone. In this manner a vibrator 30 can shake the cartridge to more evenly cook the popcorn/food in the cartridge. FIGS. 4-5 show the cooking device without the cartridge therein, but it is understood that the cartridge would fit in the receiver 25 and heat up as a result of the induction, thus causing kernels to pop and be directed into the cup 22 as a result of the lid shape.

The cartridge can be filled with popcorn, for example organic or non-organic varieties. Additionally, the fat/oil may be vegetable/canola oil, soybean oil, olive oil, butter, dairy butter, margarine, ghee, grapeseed oil, or other fats/oils or combinations thereof. A seasoning may be added such as salt, pepper, spices and spice mixtures or other flavorings and combinations thereof. The popcorn, fat/oil and seasoning are combined in the cartridge and sealed with the lid to avoid spilling and then the lid is removed when the user is ready to cook the popcorn. Although popcorn is shown specifically, it is understood that other food can be included. For example, such other foods could include, e.g., soups, dry/dehydrated foods to which the user adds water to the cartridge for cooking (e.g. rice, noodles, vegetables, sauces/seasonings and combinations thereof).

The thickness of the heating plate or the bottom of the cartridge (e.g. when a conductive non-ferrous material) is within the 12-35 gauge range so as to provide for adequate heating and structure. The thickness must be sufficient to provide adequate durability during transport and so that the cartridge retains its shape under normal forces encountered during use. If made from material too thin such as the thickness of e.g. aluminum foil or paper, the cartridge would likely collapse during shipping or use. However, if the material is too thick, induction based heat generation becomes more difficult to generate. Specifically, the thickness of the material in which induction currents are generated impacts the resistance. A higher thickness results in less resistance, meaning more current needs to be generated to create heat, thus requiring a stronger magnetic field and more power to cook. However, if the thickness is within the above referenced range and the right frequency is selected, it has been found that adequate heating can be generated through induction. In preferred embodiments the induction coil 28 is driven to oscillate at 20 KHz-200 KHz. Skin effect is the tendency of an alternating electric current (AC) to become distributed within a conductor such that the current density is largest near the surface of the conductor and decreases exponentially with greater depths in the conductor. The electric current flows mainly at the “skin” of the conductor, between the outer surface and a level called the skin depth. Skin depth depends on the frequency of the alternating current; as frequency increases, current flow becomes more concentrated near the surface, resulting in less skin depth. Skin effect reduces the effective cross-section of the conductor and thus increases its effective resistance. Thus, a thicker material with relatively low resistivity and resistance can be driven at a given frequency to obtain higher resistivity by concentrating the induced currents in the skin depth. Because the cup when formed of aluminum has low resistivity and a (relatively) large cross section, the frequency of the induced current is selected such that the “skin-effect” phenomena traps the current in the outer skin of the cup, reducing the cross sectional area of the path taken by the current. Since the cross-sectional area of the current path is very small, the resistance becomes large enough that a practical amplitude of induced current can dissipate sufficient power to cook. Further, as the conductor (e.g. the aluminum of the cup) heats up, its resistivity increases.

In the frequency regime used, the skin depth can be approximated as:

$$δ = \sqrt{\frac{2 ρ}{ω μ}} .$$

Here, δ is skin depth in meters,ρ is the resistivity of the material,ω is the radian frequency or 2π*frequency, and μ is the permeability of the material.

As shown by the chart above, for conductive foils less than 0.15 mm thick, the skin effect is not required to confine the current—the thinness of the material is sufficient to confine the current. In this case, a heating disc 14 of a non-ferromagnetic material could be used and could run at a relatively low frequency. For example, a paper cup with a thin foil of conductive material which may be a non-ferro magnetic material. However, since a thicker skin is desirable in some cases for structural and transport reasons, the operating frequency is therefore adjusted such that sufficient eddy currents are generated to result in heating and such that resistance is high enough to turn that current into heat.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A cooking cartridge comprising:
a bottom and a sidewall forming a vessel having a cavity;
food matter contained in the cavity;
a lid which closes the cavity such that the food matter is retained in the cavity when the lid is closed and such that the food matter is removable from the cavity when the lid is opened; and
the vessel containing a non-ferrous material which is a conductive or resistive material.

2. The cooking cartridge of claim 1 wherein the non-ferrous material is configured to interact with an induction coil to heat the food matter within the cavity.

3. The cooking cartridge of claim 1 wherein the food matter comprises popcorn which is un-popped.

4. The cooking cartridge of claim 3 wherein the food matter further comprises a fat material.

5. The cooking cartridge of claim 4 wherein the food matter further comprises a flavor or seasoning.

6. The cooking cartridge of claim 4 wherein the fat material is a plant or vegetable based oil.

7. The cooking cartridge of claim 1 wherein the non-ferrous material is aluminum and the bottom and sidewalls are formed of aluminum.

8. The cooking cartridge of claim 7 wherein the bottom has a thickness of 12-35 gauge.

9. The cooking cartridge of claim 1 wherein the non-ferrous material is graphite.

10. The cooking cartridge of claim 1 wherein the sidewall is round and the vessel has an aspect ratio of at least 2 which aspect ratio is measured by diameter/height of the cavity.

11. The cooking cartridge of claim 10 wherein the aspect ratio is at least 3.

12. The cooking cartridge of claim 1 wherein the lid is adhered to a rim or edge of the vessel with a pressure sensitive adhesive.

13. The cooking cartridge of claim 1 wherein the food matter comprises unpopped popcorn and a fat with an unpopped popcorn to fat ratio of between 30:6 and 30:15 by weight.

14. The cooking cartridge of claim 13 wherein the unpopped popcorn to fat ratio is between 30:8 and 30:12.

15. The cooking cartridge of claim 1 wherein the bottom and/or sidewall are formed of a different material than the non-ferrous material.

16. The cooking cartridge of claim 15 wherein the bottom and/or sidewall are formed of a compostable material.

17. A cooking cartridge comprising:
a bottom and a sidewall forming a vessel having a cavity, the bottom and sidewall formed of aluminum;
food matter contained in the cavity, the food matter comprising unpopped popcorn and a fat.

18. The cooking cartridge of claim 17 further comprising:
a lid which closes the cavity such that the food matter is retained in the cavity when the lid is closed and such that the food matter is removable from the cavity when the lid is opened.

19. The cooking cartridge of claim 17 having an unpopped popcorn to fat ratio of between 30:6 and 30:15 by weight.

20. The cooking cartridge of claim 19 wherein the unpopped popcorn to fat ratio is between 30:8 and 30:12.

21. The cooking cartridge of claim 17 wherein the bottom has a thickness of 12-35 gauge.

22. The cooking cartridge of claim 17 wherein the sidewall is round and the vessel has an aspect ratio of at least 3 which aspect ratio is measured by diameter/height of the cavity.
